(19) United States
(12) Patent Application Publication
(10) Pub. No.: US 2014/0287230 A1
(43) Pub. Date: Sep. 25, 2014

(54) NANOSTRUCTURED POLYMER-INORGANIC FIBER MEDIA

(71) Applicants: RESEARCH TRIANGLE INSTITUTE, Research Triangle Park, NC (US); NORTH CAROLINA STATE UNIVERSITY, Raleigh, NC (US)

(72) Inventors: Howard J. Walls, Apex, NC (US); David S. Ensor, Chapel Hill, NC (US); Christopher J. Oldham, Raleigh, NC (US); Gregory N. Parsons, Raleigh, NC (US)

(73) Assignees: RESEARCH TRIANGLE INSTITUTE, Research Triangle Park, NC (US); NORTH CAROLINA STATE UNIVERSITY, Raleigh, NC (US)

(21) Appl. No.: 14/356,755

(22) PCT Filed: Nov. 9, 2012
(86) PCT No.: PCT/US12/64391

§ 371 Date: May 7, 2014

Related U.S. Application Data
(60) Provisional application No. 61/558,248, filed on Nov. 10, 2011.
(60) Provisional application No. 61/562,856, filed on Nov. 22, 2011.

(51) Int. Cl. B01D 39/08; D03D 1/00; D03D 15/00; D04H 1/728

(52) U.S. Cl. CPC B01D 39/08; D04H 1/728; D03D 1/00; D03D 15/0061
USPC 428/338

(57) ABSTRACT

A fiber media and a filter device. The fiber media has a plurality of nanofibers formed of a polymer material, having diameters less than 1 micron, and formed into a fiber mat. A barrier layer is disposed on the nanofibers to prevent dissolution of the nanofibers in the fiber mat upon exposure of the fiber mat to a solvent of the polymer material. The barrier layer coated nanofibers have a maximum strain before breakage of at least 2%. The filter device includes the fiber media and a support attached to the fiber mat.

### CROSS-REFERENCE TO RELATED APPLICATIONS

This application is related to and claims priority under 35 U.S.C. 119 to U.S. Ser. Nos. 61/558,248 and 61/562,856 filed Nov. 10, 2011 and Nov. 22, 2011, both entitled NANOSTRUCTURED POLYMER-INORGANIC FIBER MEDIA, the entire contents of which are incorporated herein by reference.

### STATEMENT REGARDING FEDERALLY SPONSORED RESEARCH OR DEVELOPMENT

This invention was made with government support under DTRA contract HDTRA1-07-C-0058. The U.S. Government has certain rights in this invention.

### BACKGROUND OF THE INVENTION

1. Field of Invention

The invention relates to more chemically resistant filtration media and methods for making the fibers and coatings for the filtration media.

2. Discussion of the Background

Due to the high curvature and heterogeneous nature of fibrous structures, existing surface modification technologies provide less than complete and uniform coverage of a textile material's surface. Current coating technologies of fibrous structures such as textiles often make use of liquid-based processes which require subsequent expensive drying or curing steps and conformality is typically less than ideal. During the chemical coating of textile goods, water is commonly used as the medium for applying the chemical treatments. The water must then be removed from the fiber or fabric during numerous rinsing and drying steps.

The type of fiber being used often determines the finishes and methods used to treat textile materials. In general, products comprising natural fibers require more processing when compared to synthetic fibers. Cotton fiber, the most used type of natural fiber, must undergo a series of preparation treatments to adequately clean the fibers for further processing. The different synthetic fibers can require very diverse finishing procedures. For example, polypropylene, a commonly used raw material in textile applications, is difficult to coat using wet treatment methods due to its hydrophobic nature.

Inorganic finishes, including coatings of silver, copper, and various metal oxides, have been used for many years in the textile industry. These coatings are often applied using solution-based methods such as a pad-dry-cure process. Applications of textile materials treated with inorganic finishes range from increasing the conductivity of material such as carpet to reduce static electricity build-up to anti-bacterial finishes for medical face masks.

A number of different methods of deposition have been used to create inorganic coatings on the surfaces of fibrous structures. One technique involves the use of sol-gels, which are nanoparticulate materials, consisting of silica and metal oxides. Sol-gel coatings can be applied at room temperature using traditional textile application techniques such as pad application, dip coating, and spraying. Electroless plating can be used to deposit a catalytically active material, such as one containing palladium, onto a fiber surface from aqueous solution. The electroless plating method often require a pre-treatment step where the fiber or polymer surface is rendered hydrophilic in order to create uniform layers of the deposited metal.

### SUMMARY OF THE INVENTION

In one embodiment of the invention, there is provided a fiber media having a plurality of nanofibers formed of a polymer material, having diameters less than 1 micron, and formed into a fiber mat. The fiber media includes a barrier layer disposed on the nanofibers to prevent dissolution of the nanofibers in the fiber mat upon exposure of the fiber mat to a solvent of the polymer material. The barrier layer coated nanofibers have a maximum strain before breakage of at least 2%.

In one embodiment of the invention, there is provided a filtration device including the fiber media and a support attached to the fiber mat.

It is to be understood that both the foregoing general description of the invention and the following detailed description are exemplary, but are not restrictive of the invention.

### BRIEF DESCRIPTION OF THE FIGURES

A more complete appreciation of the invention and many of the attendant advantages thereof will be readily obtained as the same becomes better understood by reference to the following detailed description when considered in connection with the accompanying drawings, wherein:

FIGS. 1A-1C are graphs of the chemical resistance and brittleness testing as a function of processing temperature and coating thickness (number of ALD cycles) for aluminum oxide (Al₂O₃) deposits on electrospun polysulfone (PSu) nanofibers, having an average diameter less than 100 nm;

FIGS. 2A and 2B are transmission electron microscopy micrographs showing two nanostructured nanofibers after atomic layer deposition of different inorganic/organic composite barrier layers;

FIG. 3A is a SEM micrograph showing the response of uncoated PSu fibers exposed to toluene, a solvent that readily dissolves PSu;

FIG. 3B is a SEM micrograph showing the response of an Al₂O₃ coated PSu fibers exposed to toluene;

FIGS. 4A and 4B are SEM micrographs showing a zincone coating applied to nylon nanofibers;

FIG. 5 is a schematic illustration depicting an electrospinning apparatus suitable for deposition of nanofibers of the present invention;

FIG. 6 is a schematic showing the fiber media of this invention in a generic air filtration system;

FIG. 7 is a schematic of a coated fiber of the present invention reacting with a nerve gas agent to neutralize the nerve gas agent; and

FIG. 8 is a schematic of a stacking process forming a hybrid filter structure of the present invention.

### DETAILED DESCRIPTION

Polymer-based nanofibers hold promise for providing improved air filtration or improved protective barrier properties for a variety of applications. However, small diameter polymer-based fibers are vulnerable to chemical exposure that can degrade their properties. To this end, the present invention provides a barrier layer on the nanofibers which protects polymer-based nanofibers while preserving properties such as morphology and mechanical strength. A few of the nanoscale materials suitable for the barrier layers of this invention nanofiber media include inorganic chemistries of aluminum oxide, zinc oxide, and titanium dioxide and hybrid chemistries of diethylzinc and ethylene glycol, trimethylaluminum and glycidol. A few processes for depositing the nanoscale coatings include atomic layer deposition (ALD), molecular layer deposition (MLD), vapor phase infiltration (VPI), and sequential vapor infiltration (SVI).

The addition of a barrier layer permits polymer-based nanofibers to be used in environments where toxic industrial chemicals (TICs) and chemical warfare agents (CWAs) exist without catastrophic consequences to the polymer-based nanofibers should these agents themselves react with the polymer of the nanofibers. The barrier layers are designed to increase the resistance to damage by chemicals of the coated/treated fibers; such that the resultant coated/treated fibers have a higher chemical resistant than the uncoated fibers.

In one embodiment, the addition of the barrier layer is added without sacrificing complete flexibility of the polymer-based nanofibers. This attribute is important when the fibers are handled and formed into filter devices. This attribute is important for fibers in service in fabrics used in garments or shelter applications where the fibers will need to tolerate flexing without breakage.

Barrier Layer Coated Fiber Structures:

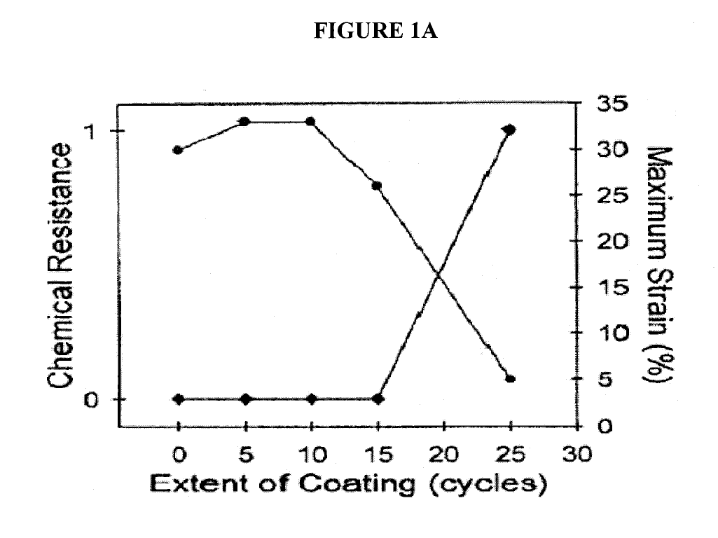

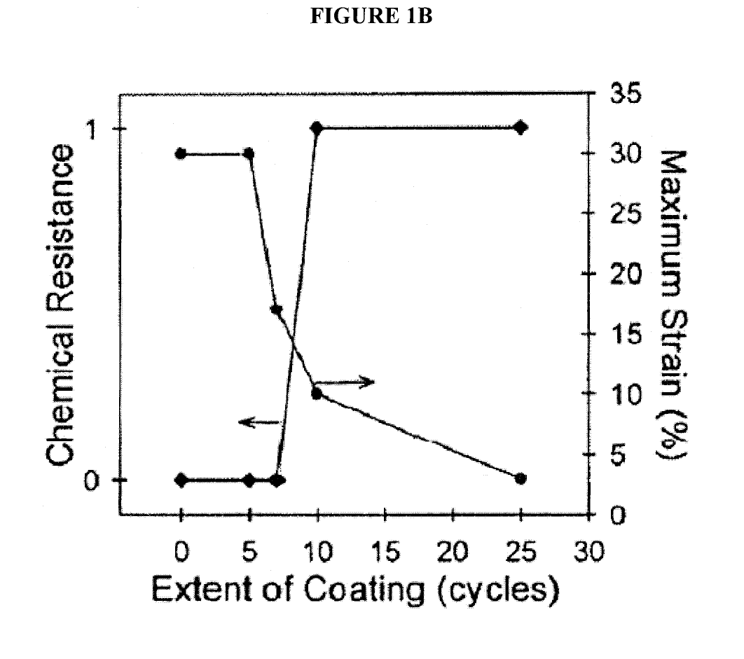

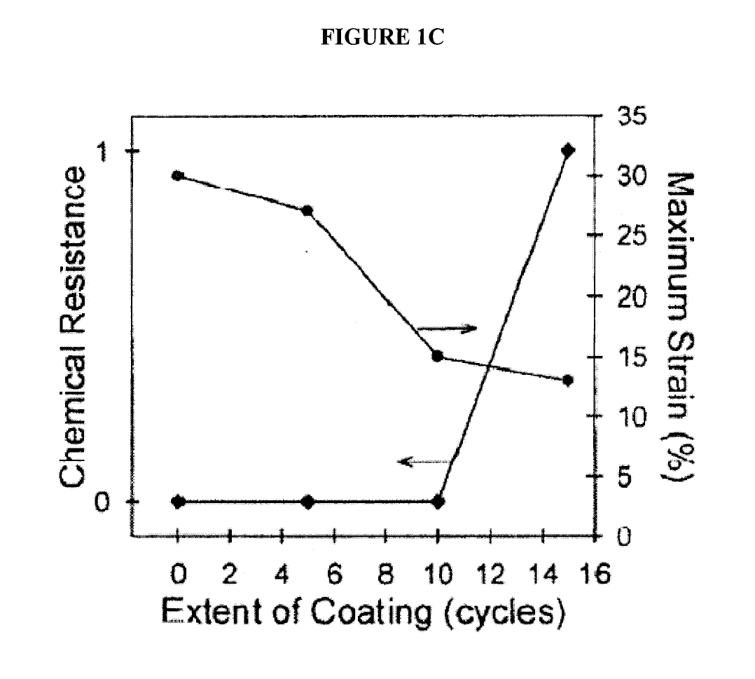

FIGS. 1A-1C show results of chemical resistance and brittleness testing as a function of processing temperature and coating thickness (number of atomic layer deposition ALD cycles) for aluminum oxide (Al₂O₃) material deposits on electrospun polysulfone (PSu) nanofibers, having an average diameter less than 100 nm.

FIG. 1A shows results for a low temperature growth of an Al₂O₃ material at 100° C. FIG. 1B shows results for a low temperature growth of an Al₂O₃ material at 60° C. FIG. 1C shows results for a low temperature growth of an Al₂O₃ material at 38° C.

To test for chemical resistance, a droplet of dimethylformamide DMF (a solvent for polysulfone) was placed on the mat and allowed to dry. Any change in the appearance of the fibers in terms of morphology, size, number of defects, etc. was deemed a fail (fail=0; pass=1). These graphs in FIGS. 1A-1C show for different thickness (i.e., number of coating cycles) a pronounced change in the property of the fibers at an inflection point where the mechanical and physical properties of the coating begins to control the mechanical and physical properties of the coated nanofiber. These graphs show, as detailed below, that fairly thin coatings (of order 1 to 10 nm) can protect an underlying nanofiber from chemical dissolution while retaining flexure without breakage.

For the strain tests shown in FIGS. 1A-1C, nanofibers were electrospun onto a metal mesh having macroscopic sized openings. A standard size sample for testing was cut from the metal mesh. A low temperature ALD process using sequential exposures of the nanofibers to trimethyl aluminum and water deposited the low temperature Al₂O₃ material around the fibers. One edge of the sample was pinned, and the parallel edge was displaced. The mat was observed under an optical microscope. The percent strain was determined by the displacement 6× divided by the reference dimension h (the height of the sample), see below.

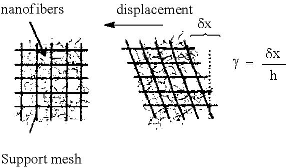

The maximum strain shown in FIGS. 1A-1C was the largest strain before any breakage of the fibers occurs. Under typical processes, e.g. 10 Al₂O₃ material deposition cycles, chemical resistance is achieved before the point that the fibers become very brittle (max strain ≦5%).

Table 1 shows the mechanical properties of a variety of samples and includes the maximum strain before breakage for chemically resistant Al₂O₃ coated PSu nanofibers. Each ALD cycle provides for example a conformal coating of 0.09-0.11 nm of Al₂O₃. In this table, the samples are Al₂O₃ material coated PSu nanofibers, coated using ALD cycles with trimethyl aluminum (TMA) and water vapor as precursors.

TABLE 1

| | CoatingTemperature | Cycles | Max strain |
|---|---|---|---|
| Samples | (° C.) | (extent of coating) | (%) |
| #1 | 100 | 15 | 13 |
| #2 | 60 | 10 | 10 |
| #3 | 38 | 15 | 13 |
| #4 | 38 | 10 | 20 |

In one aspect of this invention, it was discovered that the thickness of the Al₂O₃ coating that provides the chemical protection is surprisingly only a few nanometers thick. To determine the coating thickness, one set of nanofibers was coated with the low temperature Al₂O₃ material at 60° C. and 10 cycles, and another set was uncoated (the control sample). SEM imaging of the fiber mat samples was conducted, and greater than 70 fibers across a transect line in the image were measured to determine the average fiber diameter. It was found that the coating made only a small increase in the average fiber diameter:

AFD_{uncoated}=82 nm and AFD_{AlOcoated}=88 nm.

Remarkably, only a few nm (e.g., 1 to 10 nm) of the low temperature Al₂O₃ material was necessary to protect the underlying polymer-based nanofiber from chemical erosion. An important point with respect to this embodiment is that the barrier has minimal to no defects (pin holes, cracks, thin spots, etc).

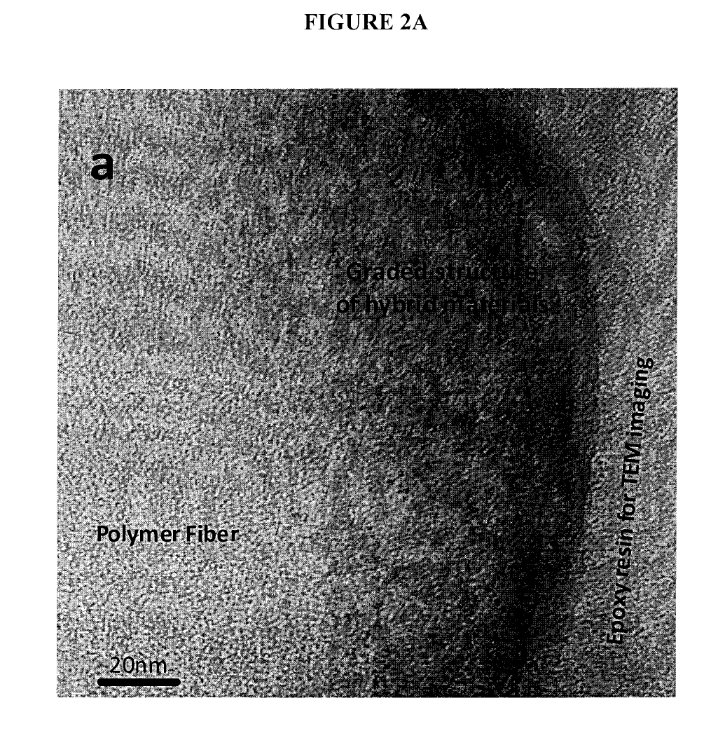

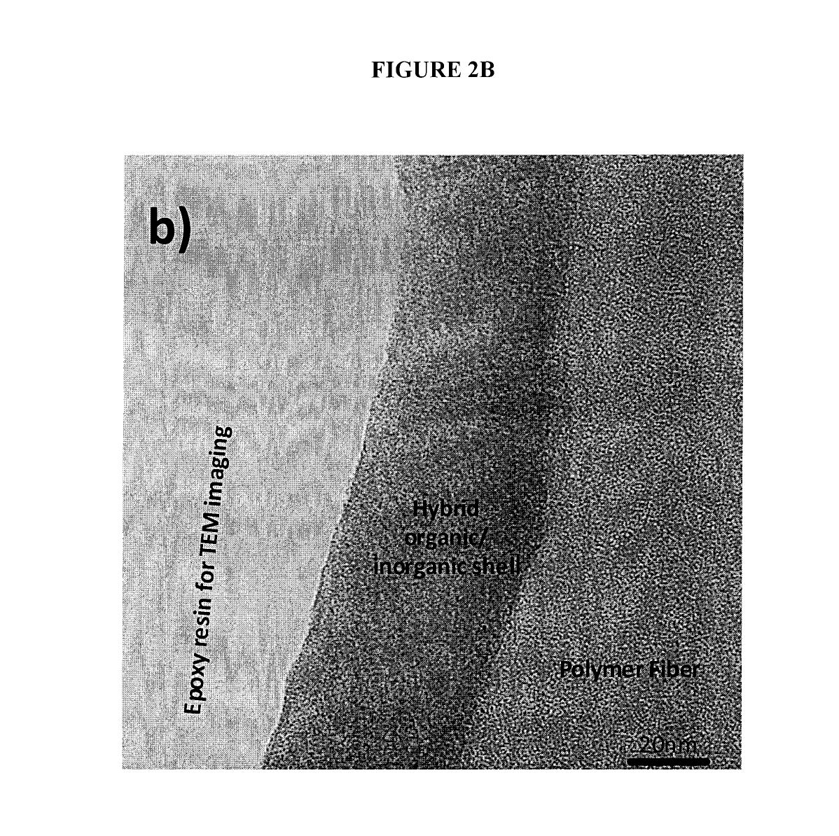

Other barrier coating materials are suitable for the invention and have been deposited on nanofibers to show the conformal coating properties desirable to protect the underlying nanofiber material. FIGS. 2A and 2B are transmission electron microscopy micrographs showing two resultant nanostructured nanofibers of nylon after atomic layer deposition of the barrier layer. FIG. 2A shows a barrier layer of the low temperature Al₂O₃ material. FIG. 2B shows a barrier layer of an aluminum-oxygen-carbon polymer, (—Al—O—(C₄H₈)—O—)ₙ. FIG. 2A shows a graded structure of hybrid organic/inorganic materials with subsurface clusters formed deep below the nanofiber surface. FIG. 2B shows a complete shell of an aluminum-oxygen-carbon polymer formed from a vapor phase sequence of trimethyl aluminum and glycidol. The resultant ALD-coated nanofibers in FIGS. 2A and 2B have a higher chemical resistance than uncoated nanofibers of the same material.

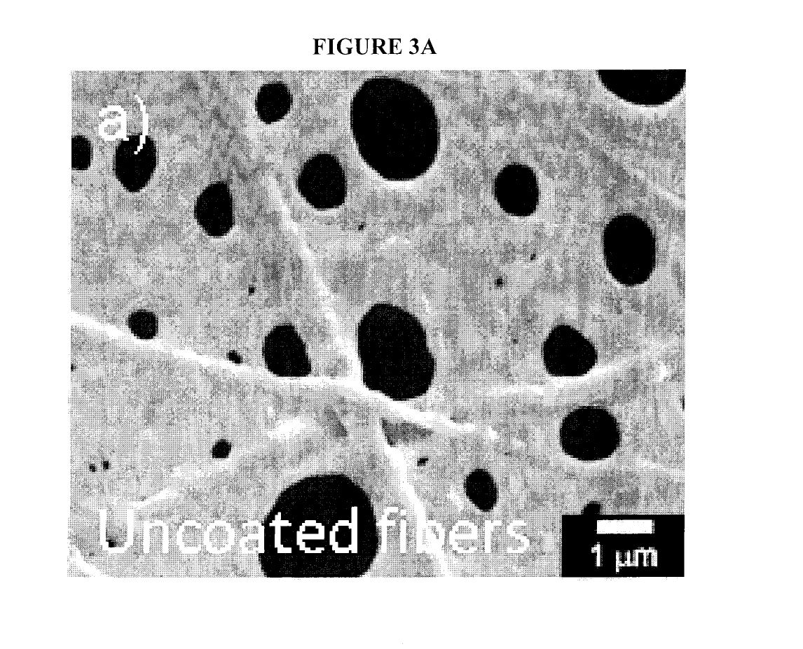

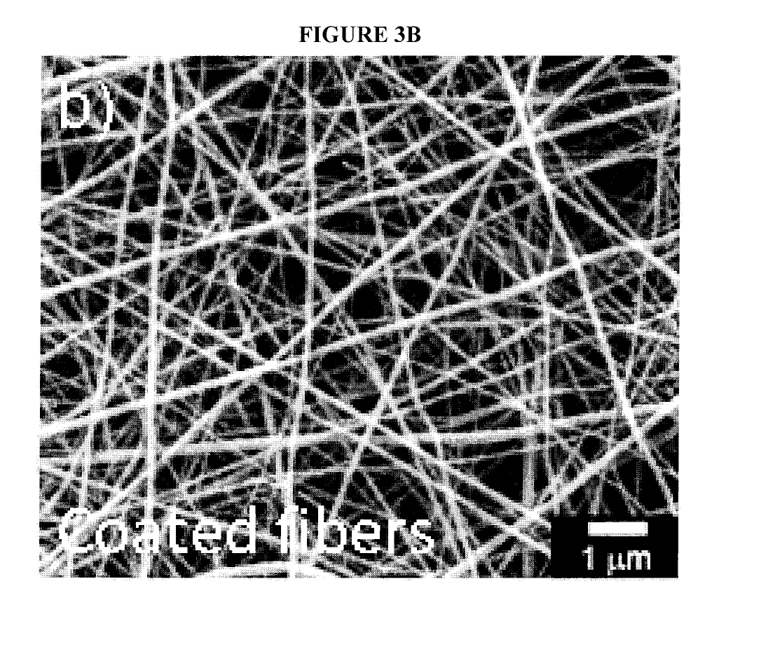

FIG. 3A is a SEM micrograph showing the response of uncoated Polysulfone (PSu) fibers exposed to toluene, a solvent that readily dissolves PSu. FIG. 3B is a SEM micrograph showing the response of an Al₂O₃ coated PSu fibers exposed to toluene. FIG. 3 provides a clear comparison of the response of uncoated and coated PSu fibers exposed to toluene, a solvent that readily dissolves PSu. A couple features of the invention are evident in the SEM of FIG. 3B. 1) The coating makes no apparent change to the fiber morphology indicating how conformal and thin it is. 2) No change in fiber morphology due to exposure to the solvent indicating excellent chemical resistance. These coated fibers were chemically resistant, have the desired morphology, and were not affected by the toluene solvent.

The chemistry of the coating reagents, the polymer fiber, and processing conditions are important to achieving the correct structure and resulting properties. In the above example, PSu electrospinning, TMA exposure for the ALD coating, and the Al₂O₃ coating at temperatures between 40° C. and 70° C. for 10 to 15 cycles achieved semi-flexible fibers with both good morphology and resistance to chemicals. This invention is not limited to this combination. Other polymer fibers and coatings are suitable for this invention, and tests such as the one shown in FIGS. 1A-1C can be used to determine the layer thickness for chemical protection.

Other polymer fibers often require different chemistries and processing conditions. For example, polyamide 6 (i.e. nylon 6) was found not to be compatible with the TMA chemistry that works well with PSu nanofibers. Alternate coating chemistries have been developed for nylon based nanofibers to provide preservation of morphology: Examples of other alternative coatings include zinc oxide, titanium dioxide, and zincone poly (zinc ethylene glycol) hybrid organic-inorganic (i.e. zincone). Other chemistries can be partially or fully coated on top of these coatings to add additional protection or functionality.

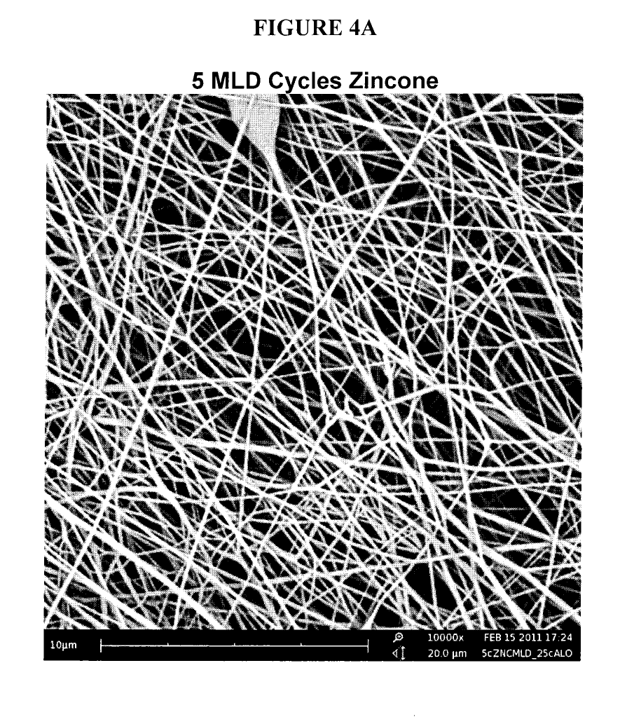

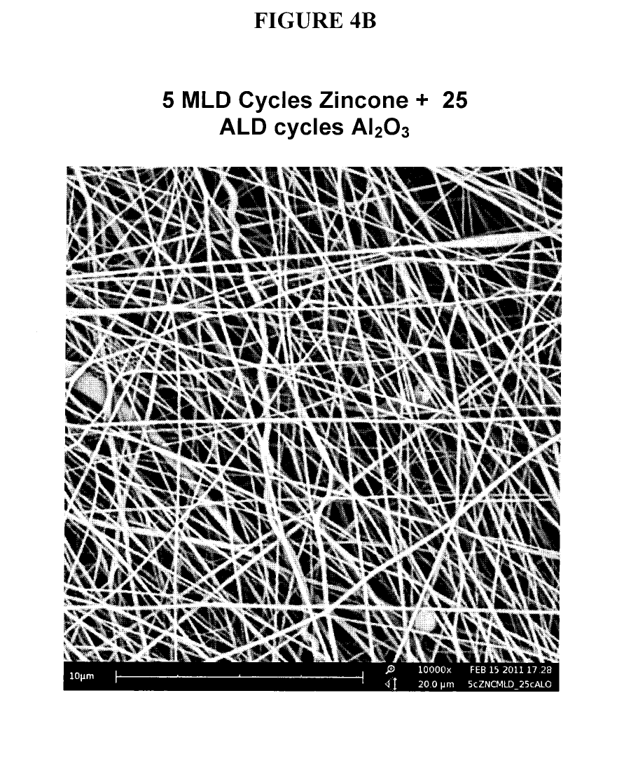

FIG. 4 shows how a zincone coating protects the nylon nanofibers against the TMA used to make Al₂O₃. Without the protective coating, nylon exposure to TMA would otherwise destroy the fibers. Titanium dioxide (as an intervening protective coating) showed even better morphology and mechanical properties than the zincone protective coating. In one embodiment of the invention, subsequent to the zincone or titanium dioxide coatings on the nylon nanofibers, Al₂O₃ material coatings similar in quality to those Al₂O₃ coatings shown above are added. In other embodiments various metalcone coatings (i.e. akin to zincone) are possible such as titanicone, zircone, alucone, to name a few. These coatings can be applied to any number of polymer nanofibers, not just nylon. In other embodiments, other layered structures similar to the zincone and Al₂O₃ structure are possible. Combinations of metalcone and metal oxide, combinations of metal oxide layers are possible.

In air filtration devices, polymer nanofibers which have a high efficiency removal of aerosols at reduced pressure drop were previously developed; see U.S. Pat. No. 7,789,930, the entire contents of which are incorporated herein by reference. In one embodiment of this invention, the addition of the barrier layer (as detailed below) is added without substantial loss of the filtering performance (i.e., figure of merit) of the resultant fiber mat. The filter figure of merit is given by FoM=−log(1-fractional efficiency)/pressure drop where the aerosol particles are 300 nm in diameter, the face velocity is 5.3 cm/s and the pressure is measured in kPa. For commercial flat sheet fiberglass high efficiency particulate air (HEPA) filter media FoM=12±2 kPa⁻¹.

Table 2 depicts the filtration performance of coated nanofiber media of this invention. For the samples in this table, nylon-based nanofibers were electrospun (with an average fiber diameters of less than 100 nm) from an electrospinning solution of nylon 6 (polyamide dissolved in a mixed solvent which is 2:1 by weight acetic acid to formic acid for a concentration of 12 wt % polymer in solution by weight. The polymer solution was electrospun through a 30 gauge needle with a constant applied voltage of 50 kV and an electrospinning gap of 12 inches. CO₂ process gas was supplied at a controlled temperature of 20° C. to 23° C. but more suitably 21.5° C. Electrospinning was performed at a relative humidity RH between 35% and 60% but more suitably between 45% and 55%. The nanofibers are deposited on a metallic mesh such as woven wire 20×20 to 60×60 mesh sizes. A clean stainless steel mesh (free of oil) is well suited to collect the fibers and form a mesh/fiber structure. The resulting FoM of these materials ranges from about 30 kPa⁻¹ to 72 kPa⁻¹ where 45 to 65 kPa⁻¹ are the most common values. The range of values is a result of defects (e.g., microscopic holes, evenness of fiber deposition), how carefully the temperature and RH are controlled, and the quality of the electrospinning solution (e.g., absence of water moisture contamination, accuracy of solution mix). Coatings of the above-noted Al₂O₃ material barrier coatings shown in Table 1 were applied. Table 2 shows the change in FoM upon application of the barrier coatings.

TABLE 2

| | Change in FoM | FoM of coated |
|---|---|---|
| Samples | due to coating | media |
| #1 | −11% | 20 |
| #2 | −30% | 31 |
| #3 | −6% | 50 |

Preserving properties such as morphology and mechanical strength is important in air filtration devices, protective garments, and/or fabric-based shelters where materials in these applications would preferably (but not necessarily) provide for passage of air and water vapor while preferably filtering/blocking passage of hazardous aerosols (e.g., toxic airborne particles). In one embodiment of this invention, the treatments and coatings for the barrier layers are designed to maintain a morphology of the fibers and fiber mat which, without the coating, would have provided the desired properties for aerosol filtration (or barrier protection) with low resistance to air flow. In another embodiment, the treatments and coatings are designed to maintain the mechanical properties of the fibers of the coated/treated fibers; such that the resultant coated/treated fibers have at least the mechanical strength of the fibers before application of the treatments or coatings.

In one embodiment of this invention, the barrier layer coatings provide a minimal change in fiber diameter. In one embodiment, the coating and treatment processes for the barrier layer coatings utilize gas-phase reagents in processes that are not line-of-sight and which provide conformal fiber coatings with minimal change in fiber and mat morphology. For applications such as in air filtration where change in fiber diameter is required to be at a minimum, the conformal fiber coatings of this invention are on the order of 10 s of nanometers or less, although coatings as thick as 100 s of nanometers are not excluded.

More broadly described, treatment and/or coating of polymer fibers and nanofibers with ALD, MLD and related processes (e.g. vapor phase infiltration, chemical vapor deposition, etc) provide a route to make nanofiber structures including barrier layers and/or intervening layers that are resistant to chemical degradation by toxic agents. These coatings or treatment processes can form inorganic or hybrid organic/inorganic coated structures. Some of the chemistries suitable for deposition on nanofiber polymers include depositions of aluminum oxide, zinc oxide, and titanium dioxide and hybrid chemistries of diethylzinc and ethylene glycol, trimethylaluminum and glycidol. By selection of reagent chemistry and processing condition for the polymer fiber to be treated, as demonstrated above with regard to the depositions on nylon, one can achieve: 1) protection of a nanofiber from chemical erosion or dissolution, 2) a fiber morphology of the fiber and fiber mat acceptable for low resistance to air flow, and 3) strengthened mechanical properties.

Neutralizing Coated Fiber Structures:

An additional consideration for filtration and fabric use is that toxic aerosols collected by these protective materials persist on the surface and can slowly off-gas hazardous vapors resulting in the need to decontaminate and/or dispose of the protective materials. In one embodiment of this invention, the treatments and coatings are designed to increase the reactive adsorption of toxic chemicals and materials (which could be biological) on the nanofiber surfaces to detoxify or decontaminate collected toxins. Thus, besides coatings on organic fibers which provide chemical resistance, this invention can provide coatings to nanofibers which can react to neutralize toxins. Reactive metal oxides, hydroxides, metals, and doped versions of these have been known for some time to have ability to degrade a variety of chemicals.

One of the most researched substances for this application is titanium dioxide, which typically is coupled with UV irradiance to achieve degradation of various organic compounds. Recently, in the scientific literature, nano crystalline materials have shown great promise for degrading various toxic organic compounds, especially toxic compounds classified as CWAs and TICs. See for example S. Rajagopalan, O. Koper, et al Chem. Eur. J. 2002; 0. Koper, E. Lucas, et al J. App. Tox 1999 and G. Wagner, P. Bertram, et al. J. Phys Chem B. 1999; G. Wagner, et. al. J. Phys. Chem. C. 2008. These authors reported on the use of powders of nanoparticles of reactive metal oxides and hydroxides. The powders are handled either as a dry power or as a slurry.

Electrospun fibrous materials, micro and nanofiber materials via electrospinning and advanced meltblown/non-woven processes have been investigated for use as protective barriers against CWAs and TICs for more than a decade. See P. P. Tsai et al, J. Adv. Materials 2002, the entire contents of which are incorporated herein by reference. Incorporation of reactive materials (enzymes, polymer functional groups, metal oxides, polyoxometallates, etc) is considered to impart decontamination capability in barrier and filtration materials.

The resultant fibrous structure of this invention can be more than a barrier preventing the transport of toxic particles. The resultant fibrous structure with its neutralizing coating detoxifies the collected material and further can neutralize toxic vapors.

One example of a neutralizing coating is zinc oxide, a compound known to provide reactive adsorption of CWAs. Polysulfone (PSu) nanofibers were prepared via electrospinning from a solution containing 20 wt % UDEL P3500 polysulfone (Solvay advanced polymers), 0.11 wt % 900 k MW polyethylene oxide (Scientific Polymer Products), 0.075 wt % Tetrabutylamonium chloride in a solvent system composed of 70 wt % dimethyacetamide and 30 wt % dimethylformamide. The solution was prepared and stirred overnight at 50° C. Fibers were electrospun from a 30 Gauge needle with a needle temperature 31° C. Electrospinning conditions were: 40 kV with a 10-inch gap, 30% relative humidity RH, and a flow about 0.1 ml/hr. Fibers were collected on cleaned 20×20 stainless steel mesh.

Nylon nanofibers were prepared via electrospinning from a solution containing 12 wt % nylon 6 (Scientific Polymer Products) in a solvent system of 2 parts (by weight) acetic acid and 1 part formic acid. The solution was prepared and stirred overnight at room temperature. Fibers were electrospun from a 30 Gauge needed with a needle temperature of 21° C. Electrospinning conditions were: 50 kV with a 12-inch gap, 47% RH, and a flow about 0.1 ml/hr. Fibers were collected on cleaned 20×20 stainless steel mesh.

Fibers, either PSu or Nylon 6, were coated in a hot-walled stainless steel tube reactor. Precursors were diethylzinc (Strem Chemicals) and deionized water (supplied as a vapor source). Argon was used as a carrier and purge gas. Growth temperature was 90° C. Fibers were coated with 50 to 100 cycles of ZnO to form a conformal coating of ZnO on the fibers. The product was a semi-flexible fiber with a ZnO coating.

Decontamination of CWAs on ZnO occurs via reactive adsorption of the CWAs; especially organophosphates. The CWAs hydrolyze on the surface of the nanocrystalline metal oxide forming nontoxic organics, acids, and bound phosphonates. In one embodiment, these neutralizing coatings are added to the chemical resistant coatings to partially or fully encapsulate the chemical resistant coated organic fibers.

Such neutralizing coatings provide new routes for modifying fiber and nanofiber filtration media to enhance the effectiveness of the filtration media against CWAs and TICs. CWAs and TICs often have plasticizer-like activity toward polymers. Aerosols of CWAs and TICs with this activity can severely degrade traditional fiber or nanofiber based filtration media. The nanofiber media, in this embodiment of the invention, capture and decompose CWAs and TICs via the reactive, high surface area coatings.

In one embodiment of this invention, the nanoscale size provides two significant advantages: i) it results in a nanofiber structure with improved stability relative to un-treated or other conventional nanofiber structures; and ii) it permits additional structures on the surface and in the subsurface region of the nanofiber media that can be used to purify air streams and protect the user, such as for example soldiers or first responders in the field. The metal oxide and hybrid organic/inorganic enhanced nanofiber media provides for improved filtration performance against CWAs and TICs without adding burden to the user of the filtration device.

Nanofiber Preparation:

Providing fibers in general which meet the criteria of a desired morphology, good mechanical properties, and chemical resistance and/or self-decontamination is a particularly difficult challenge. To start, the fiber structures as fabricated and prior to treatments and coatings need to show the requisite size and morphology. Afterwards, the treatments and coatings need to improve (or at least not degrade) the properties such as to not make a resultant filter or fabric unusable.

U.S. application Ser. No. 10/819,945, filed Apr. 8, 2004, entitled “Electrospinning in a Controlled Gaseous Environment,” the entire contents of which are incorporated herein by reference, describes a number of ways to produce fibers with a desired morphology and desired mechanical properties.

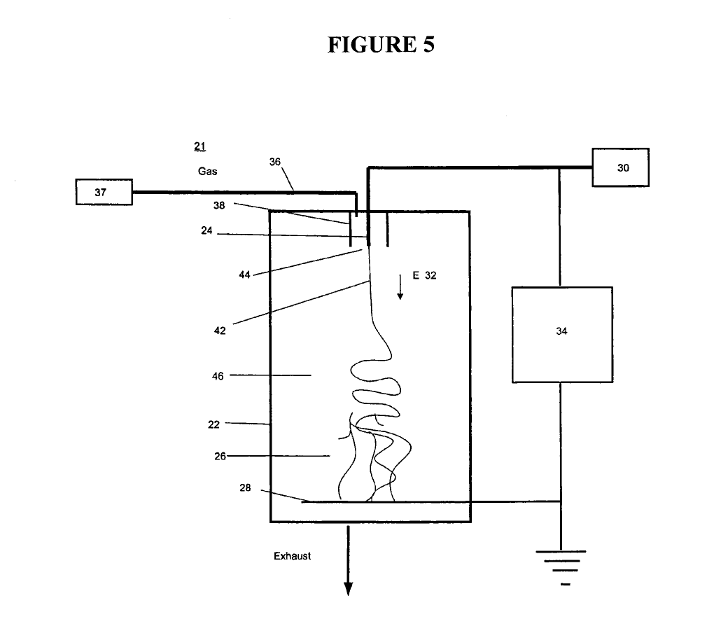

FIG. 5 is a schematic illustration depicting an electrospinning apparatus suitable for deposition of nanofibers of the present invention. In FIG. 5, electrospinning apparatus 21 includes a chamber 22 which surrounds an electrospinning element 24. As such, the electrospinning element 24 is configured to electrospin a substance from which fibers are composed to form fibers 26. The electrospinning apparatus 21 includes a collector 28 disposed from the electrospinning element 24 and configured to collect the fibers.

The electrospinning element 24 communicates with a reservoir supply 30 containing the electrospin medium such as for example the above-noted polymer solutions. The electrospin medium of the present invention includes polymer solutions and/or melts known in the art for the extrusion of fibers including extrusions of nanofiber materials. Indeed, polymers and solvents suitable for the present invention include for example polystyrene in dimethylformamide or toluene, polycaprolactone in dimethylformamide/methylene chloride mixture (20/80 w/w), poly(ethyleneoxide) in distilled water, poly(acrylic acid) in distilled water, poly(methyl methacrylate) PMMA in acetone, cellulose acetate in acetone, polyacrylonitrile in dimethylformamide, polylactide in dichloromethane or dimethylformamide, and poly(vinylalcohol) in distilled water. Thus, in general, suitable solvents for the present invention include both organic, inorganic solvents or aqueous solution in which polymers can be dissolved.

A high voltage source 34 is provided to maintain the electrospinning element 24 at a high voltage. The collector 28 is placed preferably 1 to 100 cm away from the tip of the electrospinning element 24. The collector 28 can be a plate or a screen. Typically, an electric field strength between 2,000 and 400,000 V/m is established by the high voltage source 34. The high voltage source 34 is preferably a DC source, such as for example Bertan Model 105-20R (Bertan, Valhalla, N.Y.) or for example Gamma High Voltage Research Model ES30P (Gamma High Voltage Research Inc., Ormond Beach, Fla.). Typically, the collector 28 is grounded, and the fibers 26 produced by electrospinning from the electrospinning elements 24 are directed by the electric field 32 toward the collector 28.

With reference to FIG. 5, the electric field 32 pulls the substance from which the fiber is to be composed as a filament or liquid jet 42 of fluid from the tip of the electrospinning element 24. A supply of the substance to each electrospinning element 24 is preferably balanced with the electric field strength responsible for extracting the substance from which the fibers are to be composed so that a droplet shape exiting the electrospinning element 24 is maintained constant.

The nanofibers suitable for this invention include, but are not limited to, acrylonitrile/butadiene copolymer, cellulose, cellulose acetate, chitosan, collagen, DNA, fibrinogen, fibronectin, nylon, poly(acrylic acid), poly(chloro styrene), poly(dimethyl siloxane), poly(ether imide), poly(ether sulfone), poly(ethyl acrylate), poly(ethyl vinyl acetate), poly(ethyl-co-vinyl acetate), poly(ethylene oxide), poly(ethylene terephthalate), poly(lactic acid-co-glycolic acid), poly(methacrylic acid) salt, poly(methyl methacrylate), poly(methyl styrene), poly(styrene sulfonic acid) salt, poly(styrene sulfonyl fluoride), poly(styrene-co-acrylonitrile), poly(styrene-co-butadiene), poly(styrene-co-divinyl benzene), poly(vinyl acetate), poly(vinyl alcohol), poly(vinyl chloride), poly(vinylidene fluoride), polyacrylamide, polyacrylonitrile, polyamide, polyaniline, polybenzimidazole, polycaprolactone, polycarbonate, poly(dimethylsiloxane-co-polyethyleneoxide), poly(etheretherketone), polyethylene, polyethyleneimine, polyimide, polyisoprene, polylactide, polypropylene, polystyrene, polysulfone, polyurethane, poly(vinylpyrrolidone), proteins, SEBS copolymer, silk, and styrene/isoprene copolymer.

Additionally, polymer blends can also be produced as long as the two or more polymers are soluble in a common solvent. A few examples would be: poly(vinylidene fluoride)-blend-poly(methyl methacrylate), polystyrene-blend-poly(vinylmethylether), poly(methyl methacrylate)-blend-poly(ethyleneoxide), poly(hydroxypropyl methacrylate)-blend poly(vinylpyrrolidone), poly(hydroxybutyrate)-blend-poly(ethylene oxide), protein blend-polyethyleneoxide, polylactide-blend-polyvinylpyrrolidone, polystyrene-blend-polyester, polyester-blend-poly(hyroxyethyl methacrylate), poly(ethylene oxide)-blend poly(methyl methacrylate), poly(hydroxystyrene)-blend-poly(ethylene oxide)).

Further refinements of the electrospinning process are described in U.S. Application Ser. No. 11/559,282, filed on Nov. 13, 2006, entitled “Particle Filter System Incorporating Nanofibers,” Attorney Docket No. 28373US-2025-2025-20, the entire contents of which are incorporated herein by reference. The practices described there can be used in the present invention to produce small diameter nanofibers whose large surface to volume ratio will enhance the sorption of chemical species in the various chemical sensors of the present invention.

In one embodiment of this invention, stainless steel extrusion tips having internal diameters (ID) from 0.15 to 0.58 mm are used. In another refinement, polytetrafluoroethane (i.e., Teflon) capillary tubes with ID from 0.07-0.30 mm are used. Both types of orifices can produce submicron fibers. For both orifices, low flow rates coupled with high voltage drops typically resulted in the smallest fiber diameters (e.g., <200 nm). In both cases, the voltage was 22 kV to 30 kV for a 17.8-25.4 cm gap (i.e., the distance between tip 16 and electrode 20). In one embodiment, CO₂ purge flow rates around needle 18 (i.e., as a gas jacket flow around and over the tip 16 in the fiber pull direction) are utilized to improve the electrospun fibers.

In one embodiment of the present invention, the relative humidity RH of the electrospinning chamber also effects fiber morphology. In one example, using 21 wt % PSu in DMAC, a high RH>65%, resulted in fibers that had very few defects and smooth surfaces but larger diameters, as compared to electrospun fibers produces at RH>65%. Low RH<13%, resulted in smaller fibers but having more defects (e.g., deviations from smooth round fibers). Modestly low RH, 40% to 22%, typically produced a small fiber size with fewer defects.

In one example, a combination of a Teflon capillary tube, an 81 Lpm CO₂ purge rate, under a RH of 30%, using PSu in DMAC produced nanofibers with an AFD of less than 100 nm. While a combination of a stainless steel capillary tube, a 131 pm CO₂ purge rate, under a RH of 30%, using PSu in DMAC produced nanofibers with an AFD of less than 100 nm.

In another example, nanofibers were electrospun with a solution of 21 wt % PSu in N,N-dimethylacetamide (DMAC), with the solution containing 0.2 wt. % of the surfactant tetra butyl ammonium chloride (TBAC). The surfactant lowers the surface tension and raises the ionic conductivity and dielectric constant of the solution. The polymer solution was spun from a 30G (ID 0.154 mm) stainless steel needle with a flow rate of 0.05 ml/hr, a gap of 25 cm between the needle and target, an applied potential of 29.5 kV DC, a CO₂ gas jacket flow rate of 6.5 lpm, and an RH in the range of 22 to 38%. Inspection by SEM indicated an average fiber diameter (AFD) of 82±35 nm with the smallest observed fibers being in the 30 to 40 nm range.

In another example, polycarbonate PC can be spun from a 15 wt % solution of polymer in a 50/50 solution of tetrahydrofuran (THF) and N,N-dimethyl formamide (DMF) with 0.06 wt % TBAC. A 30 gauge stainless steel needle, a polymer solution flow rate of 0.5 ml/hr, and a CO₂ flow rate of 8 lpm were used with a gap of 25.4 cm and applied potential of 25 kV to obtain sub 200 nm fibers. Inspection by SEM indicated an AFD of 150±31 nm with the smallest fibers being around 100 nm.

To obtain aligned nanofibers, both electrodes might be grounded or held at a potential of opposite polarity (relatively to the spinhead). Further, techniques as described in U.S. application Ser. No. 10/819,916, filed on Apr. 8, 2004, entitled “Electrospinning of Polymer Nanofibers Using a Rotating Spray Head,” the entire contents of which are incorporated herein by reference, can be used in the present invention to produce oriented fibers. In a rotatable spray head design, an electrospray medium is electrospun from one or more rotating electrospinning elements connected to a rotatable spray head. Electrospray medium upon extraction from a tip of the electrospinning elements is guided along a direction of the electric field toward the collector, but is deflected according to the centrifugal forces on the electrospun fibers, which provides the mechanism for orienting the fibers.

To obtain nanofibers which exhibit high figures of merit and which show a degree of local orientation with respect to the mesh upon which the fibers are deposited, an abruptly changing electric field, as described in above-noted U.S. Pat. No. 7,789,930, the entire contents of which are incorporated herein by reference. An abruptly changing electric field provides a mechanism for dynamic electric field electrospinning which in combination with the controlled environment (such as the relative humidity) can produce fibers for filters, filter devices, or filter materials with lower pressure drop and/or better filtration efficiency

In this technique, a support mesh collects and supports the nanofibers. Nanofibers having an average fiber diameter (AFD) of 200 nm or less are electrospun onto the support mesh. The nanofibers are electrospun under the conditions in which an enclosure permits control of the electrospinning environment through aspects such as CO₂ purging of the electrospinning environment, control of the relative humidity, and control of solvent vapor pressure.

The mesh has macroscopic openings that in one non-limiting example are about 1.4 mm by 1.4 mm and that contributes minimally to the pressure drop across the filter, yet provides structural support for the nanofibers. The mesh can be made from wires having a diameter of 0.1 mm. Carbon dioxide CO₂ process gas 26 is introduced with the humidity controlled to between 20% and 40% RH using a mixture of dried CO₂ and humidified CO₂. A polymer solution (e.g., 21 wt % polysulfone in solvent dimethylacetamide) from reservoir 3 flows to electrospinning emitter/orifice, which is connected to high voltage power supply. An electric field present at the end of the orifice extracts the polymer solution from the orifice forming fibers of the polymer solution.

Control of the electrospinning environment and selection of the polymer(s) solvent(s) system provides electrospun fibers to be deposited on the mesh or on themselves in a state in which the nanofibers are not completely dry of the solvent. The fibers then bond to the mesh and/or bond to each other forming an integral mesh/fiber filter structure.

Conformal Coating Deposition:

In one embodiment, this invention utilizes atomic layer deposition (ALD), molecular layer deposition (MLD), vapor phase infiltration (VPI), and/or sequential vapor infiltration (SVI) to deposit conformal coatings on nanofibers of a fiber mat or fibrous structure. ALD is a vapor phase process where binary series of chemical reactants are deposited one monolayer at a time. Metal oxides (ceramics) can be deposited in this manner. Since the reactions are self-limiting and occur on a surface of the fibers, highly uniform coatings on fibers can be achieved.

Film growth during ALD includes a set of sequential, self-limiting deposition processes that operate on the principle of alternating, saturating surface reactions. These surface reactions can be implemented by directing gaseous or vaporized source materials alternately into a reactor and thereafter purging the reactor with an inert gas between the precursor and reactant pulses. The vapor-phase precursor forms a (sub)monolayer of the precursor material on the substrate surface as the precursor molecules react with available surface groups, creating a saturated surface. Since this reaction is self-limiting, the process can expose a nanofiber-based fibrous mat for a time sufficient for the reactant to cover all available sites in the “bulk” of the fiber mat without excessive attachment of the reactive material on the outer layer fibers Excess precursor can be removed by introducing an inert purge gas, such as Ar.

A vapor-phase reactant can then be introduced into the reaction chamber where the vapor-phase reactant can react with the adsorbed precursor layer to form a thin film of the target material. Excess of the reactant material and by-products of the surface reactions can be removed by the pulsing of the purge gas. The ALD process is based on controlled surface reactions of the precursor and reactant chemicals. The steps of pulsing and purging can be repeated in a sequential fashion, allowing the thickness of the deposited film to be accurately controlled by the number of cycles the process is repeated. The alternating, stepwise nature of the ALD method can prevent gas-phase reactions during the process.

The ALD technique can permit the controlled deposition of thin films of up to about 0.5 nm per cycle, providing a method for precise control over coating thickness. The growth rate can be adjusted by changing a number of parameters in the ALD process. A wide variety of materials can be deposited on nanofibers by ALD including metals, metal oxides, metal nitrides, polymers, organic-inorganic hybrid layers, and other materials. Specifically, in this invention, the deposition of materials, such as Al₂O₃, TiO₂, TiN, and SiO₂ for example, can be conducted by ALD at relatively low temperatures (e.g., less than about 150° C. as demonstrated above), thereby limiting thermal damage to temperature-sensitive materials such as polymer-based nanofibers.

In one embodiment of this invention, an aluminum oxide material coating is obtained by exposing samples in a low pressure reactor to the precursor trimethylaluminum (TMA) followed by purging with Ar gas, then reacting with deionized water, and another Ar purge. This binary pair of reactions (exposing to TMA and deionized water) constitutes one cycle. By the self-limiting reactions of single layer coverage of TMA and activation of the TMA by water results in a single layer of aluminum oxide being formed thus providing for Angstrom level control of the coating process. Providing thin layers of aluminum oxides (e.g., less than 100 nm) produces (as noted above) a semiflexible passive coatings of the inorganic fiber.

More specific details of an ALD process suitable for this invention are set forth in U.S. Pat. Appl. Publ. No. 2009/0137043 which describes a method for modifying the surface of a fiber-based substrate. The entire contents of U.S. Pat. Appl. Publ. No. 2009/0137043 are incorporated herein by reference.

For example, an ALD process (or the other MLD, VPI, SVI processes above) can include a set of sequential reactions carried out within a closed system at a pressure ranging from 0.5 Torr to 1000 Torr. The thin films can be deposited at a range of temperatures from 25 to 200° C. The reaction temperature used can be determined by the nature of the nanofibers that is used and the characteristics of the coating desired. When working at lower temperatures, precursors and reactants of sufficient reactivity, such as trimethylaluminum and water, can be used. Examples of materials that can be deposited to form ultrathin conformal coatings include, but are not limited to, aluminum oxide, titanium nitride, and titanium dioxide.

In one example of this conformal coating process, the inorganic/organic film coating of FIG. 2B was grown using trimethyl aluminum (TMA) and heterobifunctional glycidol (GLY) at moderate temperatures (90-150° C.), producing a relatively stable organic/inorganic network polymer of the form (—Al—O—(C₄H₈)—O —)ₙ. A variety of polymers (such as nylons, polysulfone, polyurethanes, etc.) can withstand these moderate temperatures. In this example, a hot wall viscous flow vacuum reactor was used to house the fiber mats during the conformal coating process. The film deposition precursors (TMA and DI—H₂O) were stored in separate containers and evaporated at 25° C. During a predetermined gas exposure time, a computer-controlled ALD solenoid valve opens to allow the effluent vapor to mix into a flowing Ar carrier gas. The GLY liquid was loaded into a bubbler and heated at 60° C., and during the GLY exposure period, Ar gas bubbled through the vessel and into the reactor. After each precursor or reactant exposure step, Ar gas continued to flow to purge the reactor of any remaining reactant or product vapor.

The steady-state process pressure was ˜1.1 Torr, and the total Ar flow rate was approximately 200 standard cubic centimeters per minute. During TMA, H₂O and GLY dose times, the transition reactor pressure increases are approximately 150, 100, 50, and 50 mTorr, respectively. A typical deposition cycle followed a TMA/Ar/GLY/Ar sequence where the exposure or purge times were 1/40/2/40 s, respectively.

In this invention, other precursor chemistries are possible for the TMA/Ar/GLY/Ar deposition cycle noted above where different inorganic and organic carriers are used. For example, ethylene glycol could be substituted for the glycidol precursor noted above. Other metal organics could be used along with or in place of trimethyl aluminum. Accordingly, this invention is not limited to the above-noted temperature ranges.

In one example (as noted above), a thin Al₂O₃ film can be produced on a fiber by a process of introducing a fibrous substrate into a reaction chamber, pulsing a vapor-phase precursor containing a selected inorganic component (e.g. Al(CH₃)₃) into the reaction chamber to create an atomic layer of a precursor on the substrate, purging the reaction chamber to remove excess vapor-phase precursor, pulsing a vapor-phase reactant (e.g. H₂O) into the reaction chamber to form Al₂O₃, purging the reaction chamber to remove excess of the vapor-phase reactant. The pulse and purge steps are repeated until a coating of the desired thickness is formed.

In some examples, a combination of layers can be deposited on the fibers, such as but not limited to metal containing layers stacked on together. Specifically, a film having alternating layers of Al₂O₃ and TiO₂ can be formed on the fibers.

Applications for Coated-Fiber Mats

Applications for the coated-fiber fiber mats of this invention include nanofiber media for use in personal protective equipment to purify air for soldiers and first responders. In general, the coated-fiber fiber mats can capture chemical agents and toxic industrial chemicals, and can also neutralize or detoxify the captured chemicals or agents.

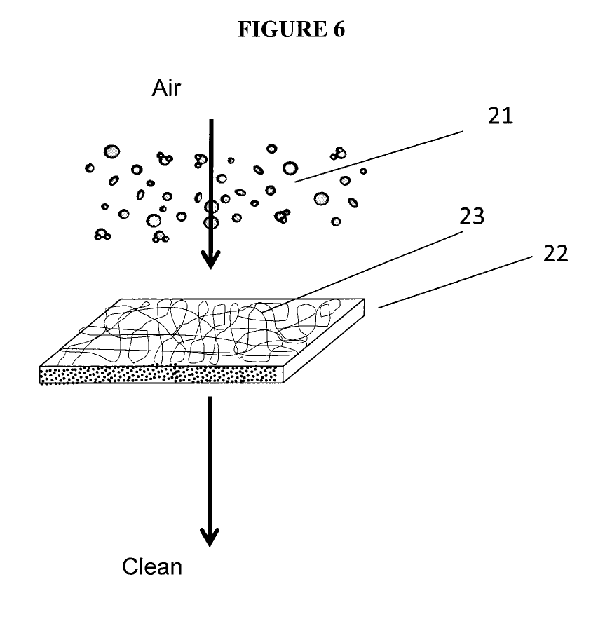

FIG. 6 is a schematic showing the fiber media of this invention in a generic air filtration system shown here in an oversimplified view but representing the use of the barrier coated nanofiber media for use in personal protective equipment to purify air for soldiers and first responders as well as for purifying air streams in residential and commercial and industrial buildings. In FIG. 6, element 21 represents a chemical aerosol for example VX, HD, or GD, element 22 represents the barrier layer coated nanofiber filter for capture and destruction of aerosols, and element 23 represents individual coated nanofibers. While shown as a flow through filter, the filtration device could equally serve as an impaction device to collect particulates upon impact and detoxify toxins in the environment of the filtration device upon interaction of the toxins with neutralizing agents in the fiber mat.

The coated-fiber fiber mats of this invention can be used as enhanced filtration media for purifying air streams in particularly in vehicles such as tanks or in portable or permanent shelters for battlefield uses. The coated-fiber fiber mats of this invention can replace the standard filtration media used in residential and commercial and industrial buildings. The coated-fiber fiber mats of this invention can in particular be used to collect and decontaminate common air contaminants such as dust, mold, pet dander, allergens, smoke particles, and volatile organic compounds (VOCs).

Other applications for the coated-fiber fiber mats of this invention include nanofiber media for use in personal protective equipment to purify air for soldiers and first responders. Other military applications include use of the coated-fiber fiber mats of this invention as an enhanced filtration media in portable or permanent shelters for battlefield uses.

One important need in protective equipment for soldiers and also air purification systems in military vehicles and temporary or fixed site shelters is a new filtration material that strengthens the protection levels against chemical or biological weapons. The technology of air purification has advanced little since World War I. Contaminated air has mainly been treated by carbon based materials such as activated charcoal. Charcoal has served as the primary material for air purification and is still the material of choice by the military. Currently activated charcoal is used in the joint services general purpose mask (JSPGPM) that is used by all branches of the U.S. Military. Current battlefield conditions and threats from terrorist attack on domestic sites demand new filtration media for protective equipment and air purification.

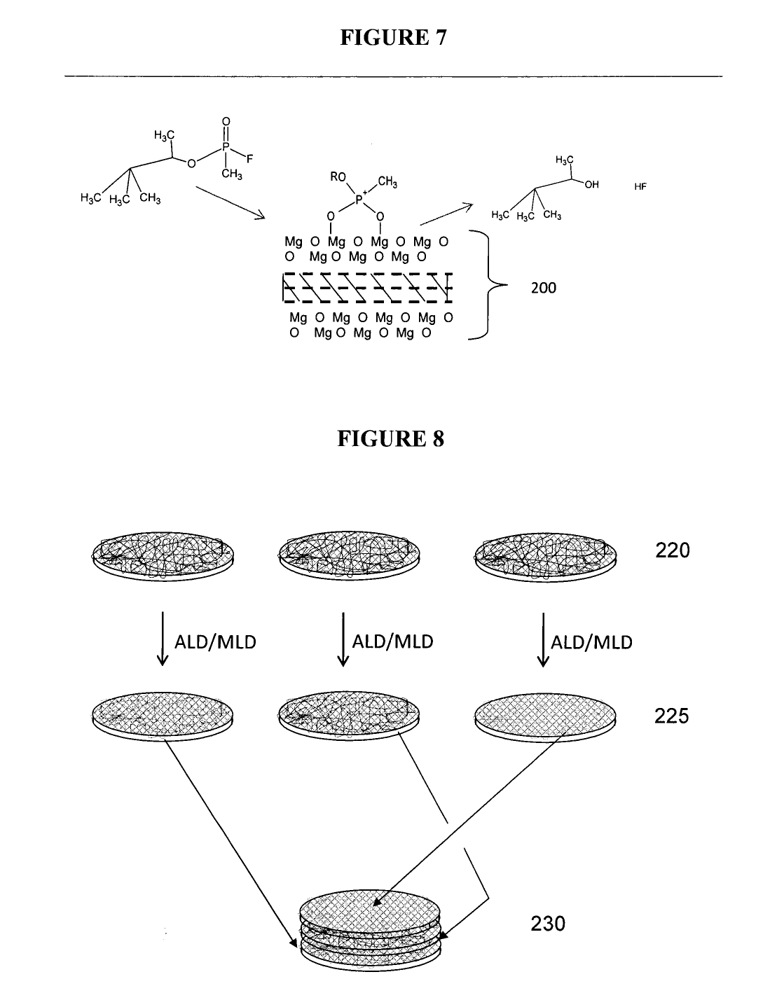

The coated-fiber fiber mats of this invention include metal oxide and hybrid organic/inorganic nanostructured materials that are designed to capture and destroy chemical aerosols. FIG. 7 is a modified schematic taken from the article by G. W. Wagner et al, J. Phys Chem B 1999, 103, 3225-3228, entitled “Reactions of VX, GD, and HD with Nanosize MgO,” the entire contents of which are incorporated herein by reference. This figure shows for this invention a coated fiber 200 having MgO outside layer which reacts with GD (3,3-dimethyl-2-butyl methylphosphonofluoridate) to reduce the nerve gas to more benign substances and traps the phosphor on the surface of the coated fiber.

In conventional nanofiber technology, metal oxide and hybrid materials are incorporated into the matrix of the nanofiber during fiber formation. The resulting nanofibers often have limited practical use because these materials are brittle or lack mechanical strength. This limits the use of the metal oxide nanofibers in filtration applications where mechanical flexibility and strength are key attributes of any technical advance in the art.

The coated-fiber fiber mats of this invention can include various structures formed on the surface and sub-surface to provide for added functionalization over traditional nanofiber media. In some instances, various precursors react only with the outer surface of the nanofiber media forming a combination of a thin film inorganic or hybrid organic/inorganic shell coating around the nanofiber material. In other instances, a hybrid matrix of the precursor materials and nanofiber media is formed on the surface or near-subsurface of the fiber. The amount of infiltration of the precursor into the polymer surface is determined by the polymer, the precursor, and the temperature. At higher temperatures (e.g. 90° C. versus 60° C.) more precursor penetrates the polymer generating a hybrid matrix of organic-inorganic.

The hybrid matrix can be can be created by separately creating layers of nanofiber media, with each layer using either the same or different polymer followed by coating of each layer using ALD and/or MLD followed by stacking the layers together to form a composite. FIG. 8 is a schematic of a stacking process forming a hybrid filter structure of the present invention. In FIG. 8, different filtration stages 220 and 225 are formed which can have for example barrier coating layers alone such as for example alumina, silica, zinc oxide, magnesium oxide, zirconia, and zirconium hydroxide layers, or barrier coating layers with neutralizing coatings or neutralizing particles such as for example titanium dioxide, alumina, aluminum, and titanium layers or particles. In one embodiment, these stages are each formed on the wire mesh substrates noted above and then placed together to form a stacked unit 230. In one embodiment, the barrier coating layers can include metals such as Pd, Pt, Ru, Rh, Co, Cu, Zn, metal carbonates, phosphonates, and other compounds, as well as hybrid organic-inorganic materials including metals, metal compounds and organic components. In the stacked unit, the electrospun layers would have high FoM (e.g., between 5 and 50 kPa⁻¹), and once stacked then the stacked unit would provide for a 99.97% or more particle collection efficiency. Different numbers of stacks having different numbers of nanofiber layers would have different (lower or higher) collection efficiencies.

An alternate method to stacking would be to use a dual electrospinning technique to simultaneously apply two different polymers. An alternate method would be to lay different polymers down sequentially.

In the case where a composite polymer mat is formed before ALD/MLD, then distinct ALD/MLD chemistries can not be readily applied but potentially the different polymers can modify the structure or deposition rate of the ALD/MLD layer to produce layers of differing effects within the hybrid structure.

In one embodiment, the resulting structures have a graded interface of metal oxide and hybrid materials that protect the core polymer structure from chemical exposure. In other embodiments, the precursors diffuse into the fiber and change the properties of the entire or partial fiber bulk. As one example, the metal organic and organic precursors can be diffused and infiltrate deep below the nanofiber surface. This could result in the formation of inorganic and hybrid clusters of materials in the nanofiber. The subsurface clusters form an intermixed and graded structure of organic and inorganic materials that protect the polymer backbone but also these clusters serve as reactive sites to enhance decomposition of the chemical agents.

In each of these examples, the mechanical properties are not compromised. Additionally, the nanofiber media does not decrease the pressure drop in the filtration apparatus or add additional burden to the user of the filtration media or apparatus.

General Aspects of the Invention

In a first aspect of this invention, a fiber media is provided which comprises a plurality of nanofibers formed of a polymer material, having diameters less than 1 micron, and formed into a fiber mat. The fiber media includes a barrier layer disposed on the nanofibers to prevent dissolution of the nanofibers in the fiber mat upon exposure of the fiber mat to a solvent of the polymer material. As used here in the specification and in the appended claims, the singular forms “a,” “an,” and “the” include plural referents unless the context clearly dictates otherwise. Thus, for example, reference to “a polymer material” includes one or more polymer materials. A reference to “a barrier layer” includes one or more barrier layers.

In this fiber media, the barrier layer coated nanofibers can have a maximum strain before breakage of at least 2%, at least 5%, at least 10%, at least 20%. In some circumstances, the maximum strain before breakage can be 30-50%.

In this fiber media, the barrier layer can comprise an inorganic-organic composite coating composed of an inorganic material and an organic material. The inorganic material can be at least one of alumina, silica, zinc oxide, magnesium oxide, zirconia, and zirconium hydroxide, metals of Pd, Pt, Ru, Rh, Co, Cu, Zn, metal carbonates, phosphonates, and compounds of hybrid organic-inorganic materials including metals, metal compounds and organic components. The inorganic-organic composite coating can have an outer surface substantially composed of the inorganic material. The inorganic-organic composite coating can comprise segregated regions of the inorganic material intermixed with the organic material. The segregated regions can comprise a graded density structure having the highest density of the inorganic material on the outer surface of the coating. The composite coating can comprise an aluminum-oxygen-carbon layer.

In this fiber media, the barrier layer can comprise at least one or more layers of inorganic material and organic material including layers having a mixture of inorganic and organic materials. The barrier layer can have a thickness between 0.5 and 50 nm, or preferably between 1 and 20 nm, or more preferably between 1 and 10 nm.

In this fiber media, the barrier layer can comprise a conformal coating less than 20 nm thick deposited on and around substantially all the nanofibers in the fiber mat, or a first material which increases a chemical resistance of the coated fiber relative to an uncoated fiber of the same material, or a second material which increases a chemical reactivity of the coated fiber relative to an uncoated fiber of the same material, or a combination thereof. The second material can comprise a material which reacts with toxins to reduce the toxins to a benign species. For example, the second material can comprise at least one of titanium dioxide, alumina, aluminum, and titanium.

In this fiber media, the nanofibers can have an average fiber diameter of less than 1 μm and in particular less than 100 nm. In this fiber media, an intervening layer can be provided between a core of the nanofiber and the barrier layer. The barrier layer can comprise a conformal coating. In one example, the conformal coating can comprise sequentially deposited atomic layers, each layer deposited from a vapor phase-precursor of a component of the barrier layer, and the intervening layer can protect a core of the nanofiber from reacting with the vapor phase-precursor.

In this fiber media, the fiber mat can comprise a flexible mat, and the barrier layer can be resilient to flexure without shattering. In this fiber media, the fiber mat can include a material which reacts with toxins to reduce the toxins to a benign species.

In a second aspect of this invention, a filtration device is provided which comprises the fiber media described above in the first aspect and a support attached to the fiber mat. In this filtration device, the fiber mat can have a figure of merit FOM greater than 5 kPA⁻¹ or greater than 10 kPA⁻¹, or between 5 and greater than 50 kPA⁻¹.

In a third aspect of this invention, at least one of a filter, a plastic foam, a metallic foam, a semi-conductive foam, a woven material, a fabric, a plastic screen, a textile, a garment, a tent enclosure, and an air filter medium include the fiber media described above in the first aspect.

In a fourth aspect of this invention, a method of trapping and detoxifying aerosols is provided which comprises 1) passing an effluent of the aerosols including particulates and toxins through the fiber media of the first aspect acting as a filtration device, 2) trapping at least the particulates in the fiber mat, and 3) reacting the toxins with neutralizing agents in the fiber mat to detoxify the toxins. In this aspect, the fiber mat can be exposed to ultraviolet or visible radiation to stimulate reactions between the neutralizing agents and the toxins.

Numerous modifications and variations of the invention are possible in light of the above teachings. It is therefore to be understood that within the scope of the appended claims, the invention may be practiced otherwise than as specifically described herein.

1. A fiber media comprising:
a plurality of nanofibers formed of a polymer material, having diameters less than 1 micron, and formed into a fiber mat; and
a barrier layer disposed on the nanofibers to prevent dissolution of the nanofibers in the fiber mat upon exposure of the fiber mat to a solvent of the polymer material; and
the barrier layer coated nanofibers having a maximum strain before breakage of at least 2%.

2-4. (canceled)

5. The media of claim 1, wherein the barrier layer comprises an inorganic-organic composite coating composed of an inorganic material and an organic material.

6. The media of claim 5, wherein said inorganic material comprises at least one of alumina, silica, zinc oxide, magnesium oxide, zirconia, and zirconium hydroxide, metals of Pd, Pt, Ru, Rh, Co, Cu, Zn, metal carbonates, phosphonates, and compounds of hybrid organic-inorganic materials including metals, metal compounds and organic components.

7. The media of claim 5, wherein the inorganic-organic composite coating has an outer surface substantially composed of the inorganic material.

8. The media of claim 5, wherein the inorganic-organic composite coating comprises segregated regions of the inorganic material intermixed with the organic material.

9. The media of claim 8, wherein the segregated regions comprise a graded density structure having the highest density of the inorganic material on the outer surface of the coating.

10. The media of claim 5, wherein the composite coating comprises an aluminum-oxygen-carbon layer.

11. The media of claim 1, wherein the barrier layer comprises at least one or more layers of inorganic material and organic material including layers having a mixture of inorganic and organic materials.

12. The media of claim 1, wherein the barrier layer has a thickness between 0.5 and 50 nm.

13-14. (canceled)

15. The media of claim 1, wherein the barrier layer comprises a conformal coating less than 20 nm thick deposited on and around substantially all the nanofibers in the fiber mat.

16. The media of claim 1, wherein the barrier layer comprises a first material which increases a chemical resistance of the coated fiber relative to an uncoated fiber of the same material.

17. The media of claim 16, wherein the barrier layer comprises a second material which increases a chemical reactivity of the coated fiber relative to an uncoated fiber of the same material.

18. The media of claim 17, wherein the second material comprises a material which reacts with toxins to reduce the toxins to a benign species.

19. The media of claim 17, wherein said second material comprises at least one of titanium dioxide, alumina, aluminum, and titanium.

20. The media of claim 1, wherein the nanofibers have an average fiber diameter of less than 100 nm.

21. The media of claim 1, further comprising an intervening layer between a core of the nanofiber and the barrier layer.

22. The media of claim 1, wherein the barrier layer comprises a conformal coating.

23. The media of claim 22, wherein:
said conformal coating comprises sequentially deposited atomic layers, each layer deposited from a vapor phase-precursor of a component of the barrier layer; and
said intervening layer protects a core of the nanofiber from reacting with the vapor phase-precursor.

24. The media of claim 1, wherein the fiber mat comprises a flexible mat and the barrier layer is resilient to flexure without shattering.

25. The media of claim 1, wherein the fiber mat includes a material which reacts with toxins to reduce the toxins to a benign species.

26-32. (canceled)
